(19) United States
(12) Patent Application Publication
(10) Pub. No.: US 2023/0028033 A1
(43) Pub. Date: Jan. 26, 2023

(54) ANIMAL AGILITY COURSE

(71) Applicant: CANINE INNOVATION INC., Rockwall, TX (US)

(72) Inventors: Alexandra C. SMITH, Rockwall, TX (US); Morgan FERRANS, Durham, NC (US); Dennis DAYMAN, Austin, TX (US)

(21) Appl. No.: 17/814,323

(22) Filed: Jul. 22, 2022

Related U.S. Application Data
(60) Provisional application No. 63/225,255, filed on Jul. 23, 2021.

(51) Int. Cl. A01K 29/00; A01K 15/02; A01K 11/00

(52) U.S. Cl. CPC A01K 29/005; A01K 15/027; A01K 11/006

(57) ABSTRACT

An agility course for use with an animal can include an obstacle, and a sensor configured to detect when the animal has traversed the obstacle. A method of training an animal can include positioning an obstacle unit and a dispenser unit so that a wireless signal can be transmitted from the obstacle unit to the dispenser unit, and transmitting the wireless signal in response to the animal traversing an obstacle of the obstacle unit.

### CROSS-REFERENCE TO RELATED APPLICATION

This application claims the benefit of the filing date of U.S. provisional application No. 63/225,255 filed on 23 Jul. 2021. The entire disclosure of the prior application is incorporated herein by this reference.

### BACKGROUND

This disclosure relates generally to animal training and monitoring and, in an example described below, more particularly provides an animal agility course.

Many people own pets or other animals, and would like for those animals to be well trained and physically and mentally healthy. An agility course is a good tool for training animals and developing their mental and physical fitness.

It will, therefore, be readily appreciated that improvements are continually needed in the art of constructing and utilizing animal agility courses. It among the objects of the present disclosure to provide such improvements.

### BRIEF DESCRIPTION OF THE DRAWINGS

FIG. 1 is a representative schematic side view of an example of a animal agility course and associated method which can embody principles of this disclosure.

FIG. 2 is a representative perspective view of a collar that may be used with the animal agility course.

FIG. 3 is a representative view of a display that may be used with the animal agility course.

FIG. 4 is a representative schematic view of a computing device that may be used with the animal agility course.

### DETAILED DESCRIPTION

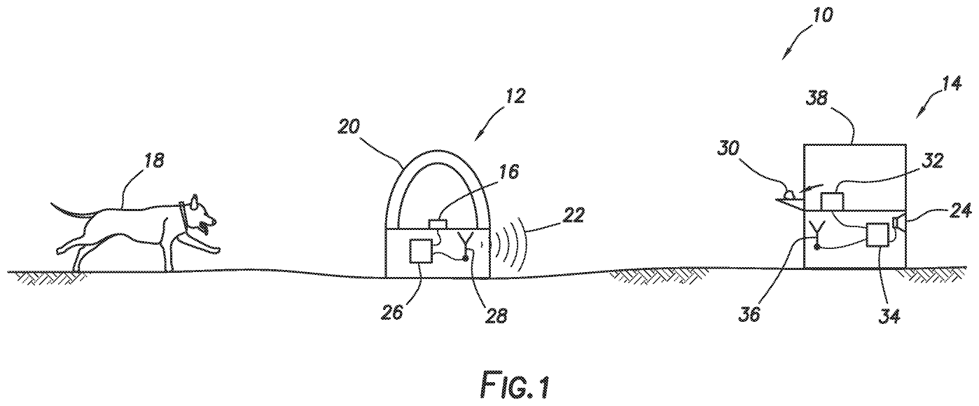

Representatively illustrated in FIG. 1 is an animal agility course 10 and associated method which can embody principles of this disclosure. However, it should be clearly understood that the animal agility course 10 and method are merely one example of an application of the principles of this disclosure in practice, and a wide variety of other examples are possible. Therefore, the scope of this disclosure is not limited at all to the details of the animal agility course 10 and method described herein and/or depicted in the drawings.

Described herein are examples of the animal agility course 10, training apparatus (such as, an obstacle unit 12 and a dispenser unit 14) and method, in which a sensor 16 (such as, a motion sensor or RFID sensor) detects when a dog 18 traverses an obstacle 20. The sensor 16 transmits a signal 22 to the dispenser unit 14 when the sensor senses that the dog 18 has traversed the obstacle 20. The signal 22 may be transmitted wirelessly to a wireless receiver 36 of the dispenser unit 14.

The dispenser unit 14 may be positioned remote from the sensor 16 and obstacle 20. The dispenser unit 14 may include an audio output device 24 (such as, a speaker or buzzer), and a sound may be produced by the device 24 in response to the signal 22 being received by the dispenser unit 14.

The sensor 16 and the obstacle 20 may be included in the obstacle unit 12, which further includes a processor 26 and a wireless transmitter 28. The obstacle 20 may comprise a hoop (as depicted in FIG. 1), a hurdle, a balance beam, a tightrope, a tunnel, a slalom course, or a combination of these or any other types of obstacles.

Also described herein is an animal agility course 10, training apparatus 12, 14 and method, in which food or a treat 30 is dispensed in response to a dog 18 (or other animal) overcoming an obstacle 20.

Also described herein is a animal agility course 10, training apparatus 12, 14 and method, in which the wireless signal 22 is transmitted, causing an actuator 32 of the dispenser unit 14 to be activated when the sensor 16 associated with the obstacle 20 detects that the dog 18 (or other animal) has traversed the obstacle. The actuator 32 causes the food/treat 30 to be dispensed from a receptacle 38 containing the food/treats.

In one example, the agility course 10 for animals comprises automated treat-dispensing. The agility course 10 is described herein as it may be used for training a dog 18 to complete the agility course, but other animals (such as, cats, parrots, horses, etc.) may be trained using the agility course 10, training apparatus 12, 14 and method.

In one example, the agility course 10 can be made up of multiple units 12, 14. Each unit 12, 14 can have its own processor 26, 34 and wireless communication capabilities. The dispenser unit 14 comprises a treat/food receptacle 38 and every time it receives a certain signal 22 it will dispense a treat or food 30.

Multiple obstacle units 12 can be connected to or otherwise associated with respective sensors 16 that are mounted onto or near each obstacle 20. An obstacle unit 12 will send the signal 22 back to the dispenser unit 14 to dispense if the obstacle 20 is completed (by the animal passing over or through, or otherwise traversing, the obstacle). The dispenser unit 14 in some examples may dispense only if all of the multiple obstacles 20 are traversed. A single obstacle unit 12 may comprise multiple obstacles 20, and the signal 22 may be sent only if all of the obstacles are traversed.

In one example, the agility course 10 can be constructed by connecting a WiFi enabled development board (such as, an “Izokee Development Board for ESP8266-12F 4M Bytes WLAN WiFi Internet Development Board Compatible with Arduino”) and a motion sensor (such as, an “Onyehn IR Pyroelectric Infrared PIR Motion Sensor Detector Modules DC 2.7 to 12V”) to separate bread boards and connecting them via WiFi. These components are available from online retailer amazon.com.

The sensor 16 can be attached to an obstacle 20 to sense when an animal 18 jumps over or through, or otherwise traverses, the obstacle, triggering a treat or food 30 to dispense from a separate dispenser unit 14 that includes the other breadboard (such as, with the Izokee Development Board).

Multiple obstacles 20 can be added to the course to make the dog 18 think and work harder before a treat/food 30 is dispensed. Sounds can be added to the dispenser unit 14 breadboard to notify the dog 18 that treats/food 30 is available and/or notify them that they have successfully completed an obstacle 20 (a suitable speaker is the “Metal Shell Round Internal Magnet Speaker 2 W 80 hm MP # Voice Decode Board TF Card U Disk 10/Serial Port/AD Board DFP layer Audio Music Module for Arduino” available from amazon.com).

In use, the dispenser unit 14 and an obstacle unit 12 are positioned next to each other. The dog 18 is urged/encouraged to traverse the obstacle 20, after which the dog is shown where the treat/food 30 is dispensed. After doing this a few times, the dog 18 should learn that the treat/food 30 is dispensed in response to the obstacle 20 being traversed.

Once the dog 18 understands the relationship between traversing the obstacle 20 and the treat/food 30 being dispensed, the obstacle unit 12 and dispenser unit 14 are moved farther apart to get the dog 18 to run back and forth across a house or yard, in one example. Additional obstacles 20 can be added (preferably one at a time) and the dog 18 can be shown that they will get a treat 30 once they traverse them all.

In some examples, indicator lights (such as, LED's, etc.) or other type of visual display may be included in each of the obstacle unit 12 and the dispenser unit 14. For example, an LED indicator light of the dispenser unit 14 may be used to indicate that treats/food 30 are available to be dispensed from the dispenser unit. An LED indicator light of the obstacle unit 12 may be used to indicate that the dog 18 has overcome or traversed the obstacle 20, and/or that treats/food 30 are available to be dispensed from the dispenser unit 14.

The sensor 16 can in some examples be a sensor capable of detecting that an animal has traversed an obstacle, and detecting which animal traversed the obstacle. For example, the presence of a collar worn by a particular dog 18 in the FIG. 1 agility course 10 could be detected by the sensor 16, with the sensor receiving identification data from the collar.

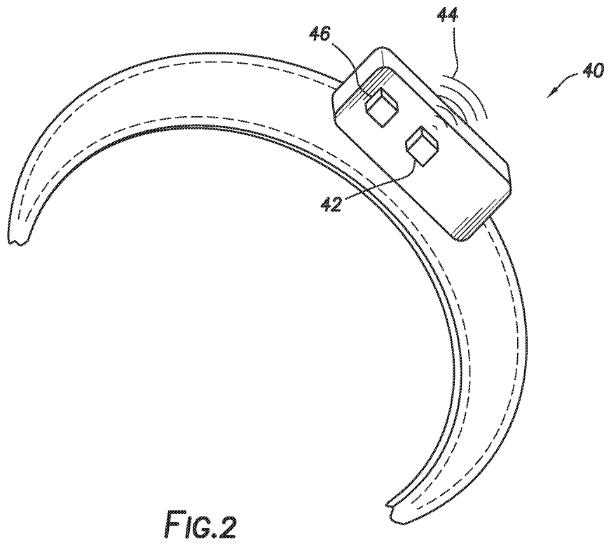

Referring additionally now to FIG. 2, an example of a collar 40 that may be used with the FIG. 1 agility course 10 is representatively illustrated. The collar 40 may also be used with other agility courses and methods, without departing from the principles of this disclosure.

As depicted in FIG. 2, the collar 40 includes a wireless transmitter 42 that can be secured to the dog 18 or other animal. The wireless transmitter 42 can transmit a wireless signal 44 to the sensor 16, for example, as an indication that the obstacle 20 has been traversed by the animal.

In some examples, the signal 44 may not be transmitted continuously. The signal 44 may be transmitted only if movement of the animal has been detected (e.g., using an accelerometer 46), or only when the collar 40 is within a certain distance of the obstacle unit 12.

In this example, the wireless transmitter 42 may be of the type known as a radio frequency identification (RFID) tag, and the sensor 16 may be an RFID reader or receiver. The wireless signal 44 transmitted by the transmitter 42 can include identification data that associates the collar 40 with the particular dog 18 or other animal wearing the collar.

One useful application of the transmitted identification data is in a situation in which multiple animals participate in the agility course 10. In that situation, the identification data can be used to ensure that only an animal that has traversed an obstacle 20 will receive a treat 30. When the wireless signal 44 including the identification data is received at the sensor 16, the processor 26 can operate the transmitter 28, so that the wireless signal 22 sent to the dispenser unit 14 includes the identification data (identifying a particular animal/collar and a particular obstacle traversed). The wireless receiver 36 of the dispensing unit 14 can receive the signal 44 (including the identification data) transmitted by the transmitter 42 of the collar 40, and can dispense a treat 30 when a particular collar (associated with a particular animal) is in close proximity to the dispensing unit. Thus, after a particular animal has traversed an obstacle 20, the dispensing unit 14 will not dispense a treat 30 until that particular animal is sufficiently close to the dispensing unit. This prevents the other animals from obtaining an unearned reward.

The accelerometer 46 can be used for a variety of different purposes. For example, the accelerometer 46 can be used to identify patterns in an animal's behavior. The identified patterns can then be used to evaluate the animal's behavior.

As an example, a pattern of data output by the accelerometer 46 can be associated with a pattern of physical activity by the animal (such as, a jump). One way of making the association between the data and physical patterns would be to observe the animal while it performs the physical pattern, and to determine what portion of the accelerometer data corresponds to that physical pattern.

An animal's behavior can be evaluated using the identified data patterns in a variety of different ways. For example, the number, frequency and/or amplitude of data patterns, and changes in these over time, can provide indications of an animal's behavior or health. An increased number, frequency and/or amplitude of data patterns corresponding to jumps by an animal can indicate that the animal's level of activity, and perhaps its overall health, is improved.

Either of the processors 26, 34 (and memory and instructions/software associated therewith) may be used to accumulate and manipulate the data received by the sensor 16 and/or the receiver 36. In other examples, a separate computing device may be used for this purpose and the computing device may receive the data via the signal 22 transmitted by the wireless transmitter 28. However, the scope of this disclosure is not limited to accumulation or manipulation of the data by any particular device, or to communication of the data to the device in any particular manner.

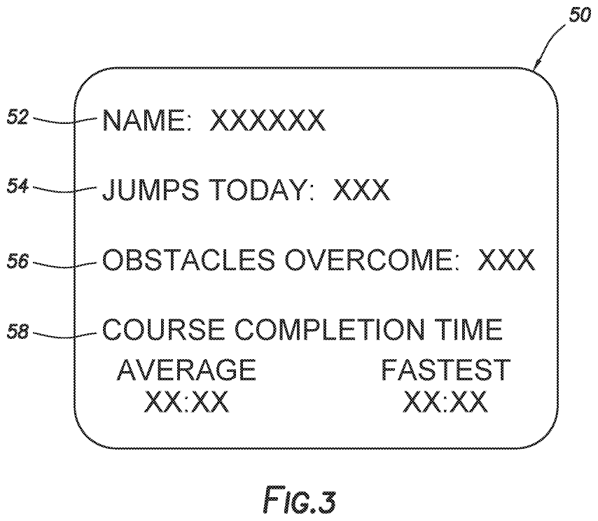

Referring additionally now to FIG. 3, an example of a display 50 output by a computing device is representatively illustrated. The display 50 may be associated with a mobile device (such as, a smartphone, a smartwatch or a tablet), a desktop computer or any other device capable of outputting to such a display.

In the FIG. 3 example, certain accumulated and calculated data is presented to a user. The display 50 includes an animal's name 52, an accumulated number of jumps performed in a day 54, a number of obstacles overcome 56, and an average and fastest course completion times 58. However, the scope of this disclosure is not limited to display of any particular data or combination of data in any particular format.

Other examples of data that may be accumulated, calculated, manipulated and/or displayed include elated time between an issued command and action by the animal, a number of times an action or physical pattern is performed, elapsed time performing an action or physical pattern, number of treats dispensed, height or amplitude of a jump, speed of a jump, etc.

The display 50 may be produced using software or an application running on the computing device. A purchase or subscription fee may need to be paid in order for the display 50 to be produced (or continue to be produced after a trial period) by the software or application.

The data can be useful for evaluating an animal's intelligence and emotional situation or progress. For example, if a dog barks continuously, but then is given the agility course 10 and stops barking, this is a sign of emotional intelligence, in that the dog used a healthy outlet for its anxiety when provided with the healthy outlet.

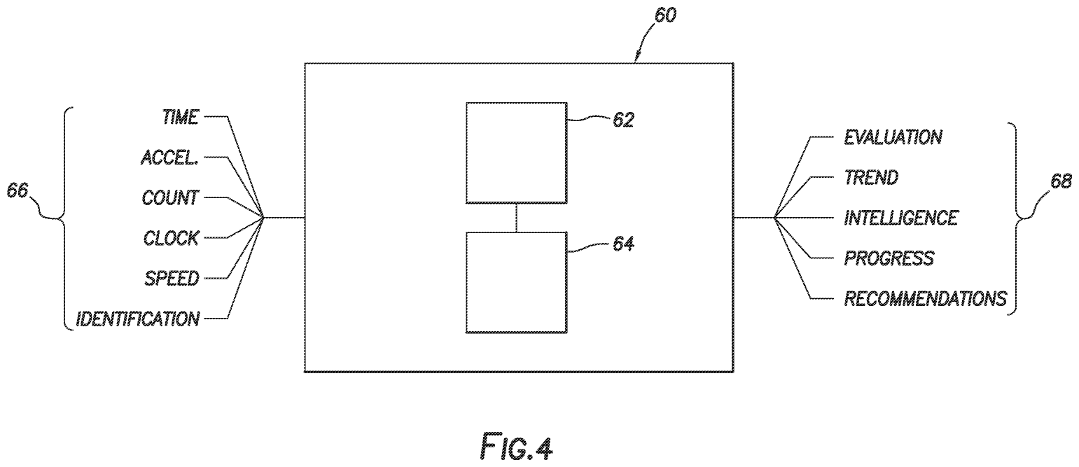

Referring additionally now to FIG. 4, a schematic view of an example of a computing device 60 is representatively illustrated. The computing device 60 may be used with the agility course 10 of FIG. 1, or the computing device may be used with other systems or methods.

As depicted in FIG. 4, the computing device 60 includes a processor 62 and memory 64. The processor 62 could comprise the processor 26 and/or the processor 34, or the processor 62 may be completely separate from the processors 26, 34. The computing device 60 may be part of the obstacle unit 12 or the dispenser unit 14, or the computing device may be separate from the obstacle and dispenser units.

In one example, the computing device 60 can be a mobile device that receives the wireless signal 22 or otherwise receives data 66 relating to an animal's activity in the agility course 10. The computing device 60 stores the data 66 in the memory 64 for use by the processor 62. The processor 62 performs calculations on the data 66, sorts the data, manipulates the data, etc., and produces output 68.

In the FIG. 4 example, the data 66 include elapsed time, acceleration (e.g., from the accelerometer 46), counts, clock time, speed and identification data (e.g., received from the transmitter 42 via the sensor 16). The output 68 can include the calculations, sorting and/or manipulated data produced by the processor 62. As depicted in FIG. 4, the output 68 includes an evaluation of the animal's activity, identified trends, an intelligence analysis, progress (or lack thereof) and recommendations. The processor 62 can format the output 68 so that it is conveniently displayed (e.g., by the FIG. 3 display 50).

It may now be fully appreciated that the above disclosure provides significant advancements to the art of constructing and utilizing animal agility courses. In examples described above, the agility course 10 can be used to exercise and train an animal, while also providing a user with valuable and actionable data on the animal's capabilities and performance.

The above disclosure provides to the art an agility course 10 for use with an animal 18. In one example, the agility course 10 can include an obstacle 20, and a sensor 16 configured to detect when the animal 18 has traversed the obstacle 20.

The sensor 16 may comprise a motion sensor or a radio frequency identification receiver.

The agility course 10 can include a dispenser unit 14. A signal 22 may be transmitted to the dispenser unit 14 in response to detection that the animal 18 has traversed the obstacle 20.

The agility course 10 may include a wireless transmitter 28 configured to transmit the signal 22 to the dispenser unit 14. The dispenser unit 14 may be positioned remote from the obstacle 20 and the sensor 16. The dispenser unit 14 may be configured to dispense a treat or food 30 in response to detection that the animal 18 has traversed the obstacle 20.

The obstacle 20 and the sensor 16 may be included in an obstacle unit 12. The obstacle unit 12 may also include a processor 26 and a wireless transmitter 28.

The agility course 10 may include a wireless transmitter 28, a receptacle 38, and an actuator 32. The actuator 32 may be configured to dispense a treat or food 30 from the receptacle 38 in response to a wireless signal 22 transmitted by the wireless transmitter 28.

The agility course 10 may include a collar 40 configured to be worn by the animal 18. The collar 40 may include a wireless transmitter 42 configured to transmit a wireless signal 44 to the sensor 16.

The above disclosure also provides to the art a method of training an animal 18. In one example, the method comprises: positioning an obstacle unit 12 and a dispenser unit 14 so that a first wireless signal 22 can be transmitted from the obstacle unit 12 to the dispenser unit 14; and transmitting the first wireless signal 22 in response to the animal 18 traversing an obstacle 20 of the obstacle unit 12.

The method can include receiving the first wireless signal 22 at the dispenser unit 14, and dispensing a treat or food 30 in response to the first wireless signal 22 receiving.

The method may include securing a wireless transmitter 42 to the animal 18. The method may include transmitting a second wireless signal 44 from the wireless transmitter 42 to the obstacle unit 12 in response to the animal 18 traversing the obstacle 20.

The method may include transmitting the second wireless signal 44 from the wireless transmitter 42 to the dispenser unit 14. The step of transmitting the second wireless signal 44 to the dispenser unit 14 may be performed after the step of transmitting the second wireless signal 44 to the obstacle unit 12.

The dispenser unit 14 may dispense a treat or food 30 in response to the step of transmitting the second wireless signal 44 to the dispenser unit 14. The first wireless signal 22 transmitting step may be performed in response to the second wireless signal 44 transmitting step.

The method may include accumulating data 66 regarding the animal 18 traversing the obstacle 20, and producing a display 50 of the data. The display 50 may be associated with a mobile computing device 60.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. An agility course for use with an animal, the agility course comprising:
an obstacle; and
a sensor configured to detect when the animal has traversed the obstacle.

2. The agility course of claim 1, in which the sensor comprises a motion sensor.

3. The agility course of claim 1, in which the sensor comprises a radio frequency identification receiver.

4. The agility course of claim 1, further comprising a dispenser unit, and in which a signal is transmitted to the dispenser unit in response to detection that the animal has traversed the obstacle.

5. The agility course of claim 4, further comprising a wireless transmitter configured to transmit the signal to the dispenser unit.

6. The agility course of claim 4, in which the dispenser unit is positioned remote from the obstacle and the sensor.

7. The agility course of claim 4, in which the dispenser unit is configured to dispense a treat or food in response to detection that the animal has traversed the obstacle.

8. The agility course of claim 1, in which the obstacle and the sensor are included in an obstacle unit, the obstacle unit further comprising a processor and a wireless transmitter.

9. The agility course of claim 1, further comprising a wireless transmitter, a receptacle, and an actuator, and
in which the actuator is configured to dispense a treat or food from the receptacle in response to a wireless signal transmitted by the wireless transmitter.

10. The agility course of claim 1, further comprising a collar configured to be worn by the animal, the collar comprising a wireless transmitter configured to transmit a wireless signal to the sensor.

11. A method of training an animal, the method comprising:
positioning an obstacle unit and a dispenser unit so that a first wireless signal can be transmitted from the obstacle unit to the dispenser unit; and
transmitting the first wireless signal in response to the animal traversing an obstacle of the obstacle unit.

12. The method of claim 11, further comprising receiving the first wireless signal at the dispenser unit, and dispensing a treat or food in response to the first wireless signal receiving.

13. The method of claim 11, further comprising securing a wireless transmitter to the animal.

14. The method of claim 13, further comprising transmitting a second wireless signal from the wireless transmitter to the obstacle unit in response to the animal traversing the obstacle.

15. The method of claim 14, further comprising transmitting the second wireless signal from the wireless transmitter to the dispenser unit.

16. The method of claim 15, in which the transmitting the second wireless signal to the dispenser unit is performed after the transmitting the second wireless signal to the obstacle unit.

17. The method of claim 15, in which the dispenser unit dispenses a treat or food in response to the transmitting the second wireless signal to the dispenser unit.

18. The method of claim 14, in which the first wireless signal transmitting is performed in response to the second wireless signal transmitting.

19. The method of claim 11, further comprising accumulating data regarding the animal traversing the obstacle, and producing a display of the data.

20. The method of claim 19, in which the display is associated with a mobile computing device.
